(19) United States
(12) Patent Application Publication
(10) Pub. No.: US 2020/0001796 A1
(43) Pub. Date: Jan. 2, 2020

(54) Pickup Rod Rack

(71) Applicant: Lloyd A. Warren, Houston, TX (US)

(72) Inventor: Lloyd A. Warren, Houston, TX (US)

(21) Appl. No.: 16/280,187

(22) Filed: Feb. 20, 2019

Related U.S. Application Data
(63) Continuation of application No. 62/670,085, filed on Jun. 27, 2018.

(51) Int. Cl. B60R 7/08; A47B 81/00

(52) U.S. Cl. CPC B60R 7/08; B60R 5/006; A47B 81/005

(57) ABSTRACT

This is a new accessory in the field of recreational fishing. It provides a safe, easy and effective way to transport fishing rod and reel combinations in the open bed of a light duty pickup truck without incurring damage or loss of any mounted equipment, utilizing lightweight assemblies that are easily mass-produced. The assemblies require no modifications to the vehicle and repeated use does not mar any visible surfaces on the vehicle. This accessory does not hinder operation of the tailgate on the vehicle so loading and unloading of other gear remains totally unobstructed.

### CROSS-REFERENCE TO RELATED APPLICATIONS

U.S. 62/670,085

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX (if Applicable)

Not Applicable

### BACKGROUND OF INVENTION

This invention is an accessory designed to protect fishing equipment, specifically (Rods and Reels) from damage during transportation in the open bed of a standard light duty pickup truck. This invention was devised after suffering damage to my own personal fishing rods when I either closed the tailgate on one or more rod tips and broke the fiberglass or had heavy ice filled coolers shift in the bed and break the eyelets from several rods. The original design prototype developed in 2001 is detailed in the drawings FIG. 1 and FIG. 2. This initial design was used with trucks that had utility post holes located at each end of the bed rails. The pieces were fastened to the truck with wooden pegs that engaged the predrilled holes in the steel bed and holes in the 5″×1½″ vertical post on the left side of each assembly as depicted in the drawings. The original design was extensively field tested from year 2001 through year 2011. The current generation is detailed in drawings designated as FIG. 3 through FIG. 7 and has been designed to slide onto the truck bed rails and are secured using eyebolts that engage the bottom of the bed rails. This makes the device adaptable for multiple domestic and foreign makes and models of full sized and some mid-sized trucks. The current design has been in use and thoroughly tested from year 2011 to the date of this submission on full size Ford, Chevrolet and Dodge pickups.

### BRIEF SUMMARY OF THE INVENTION

This two-piece invention was devised and developed in June 2001 to securely hold fishing rod and reel combinations in the open bed of any standard pickup truck with unobstructed bed rails. The components are designed to quickly and easily fasten to the vehicle bed rails without damaging or marring the visible rail surface material. The presented design holds six rod and reel combinations, but a slight modification can increase the capacity to nine or twelve while maintaining the functional and aerodynamic properties of the devices.

### BRIEF DESCRIPTION OF THE SEVERAL VIEWS OF THE DRAWING

This paragraph details the first generation drawings only. Both drawings contain exact dimensions for each component in the assemblies.

FIG. 1 shows the functional view of the lower (forward) rack assembly that cradles the rod handles as seen from the rear of the truck. This view shows the capacity of six rod and reel combinations and the manner of fastening the device to the bed rail of the truck utilizing a wooden dowel capped with a metal ring. The drawing also lists full dimensions for each part of the assembled device.

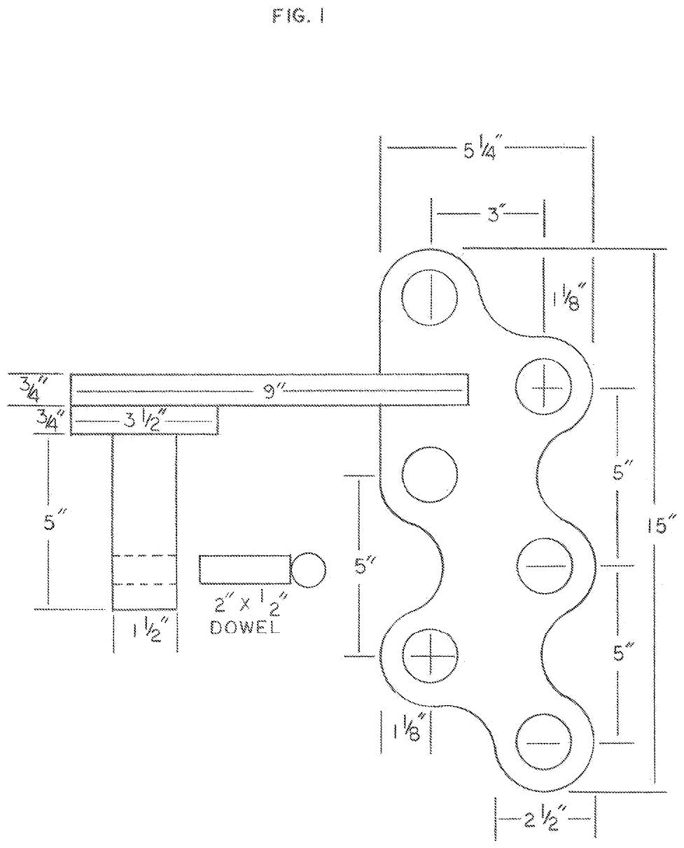

FIG. 2 shows the functional view of the upper (rear) rack assembly that supports the tips of each rod and was originally designed for baitcast rods only. The original design did not make any allowances for the larger eyelets of a spinning rod. This view also exhibits the same fastening method depicted in FIG. 1

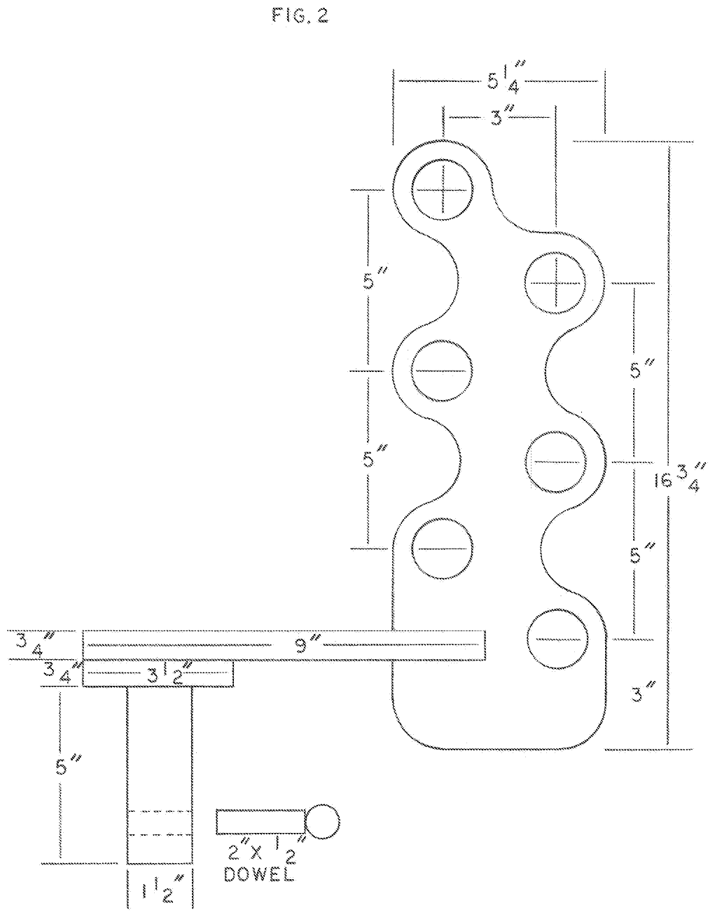

This paragraph details the current version of the Pickup Rod Rack to be evaluated for this Non-Provisional Utility Patent Application submission. All drawings contain exact dimensions for each component of the assemblies.

FIG. 3 shows the functional view of the lower (forward) rack assembly that cradles the rod handles and displays the current method of attaching the unit to the pickup bed rails with the threaded 4″×¼″ eyebolt.

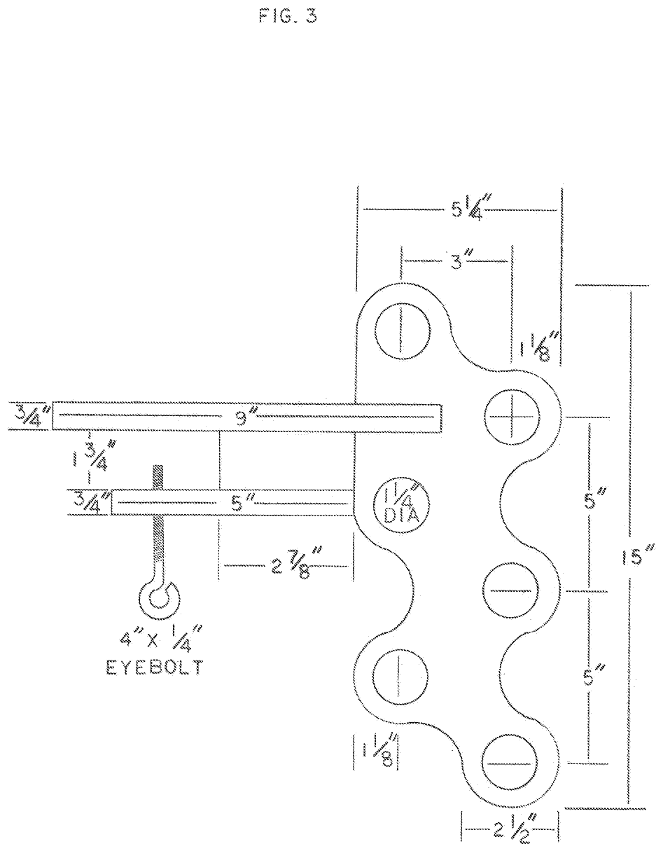

FIG. 4 shows the lateral view of the lower component and also provides full dimensions of that view.

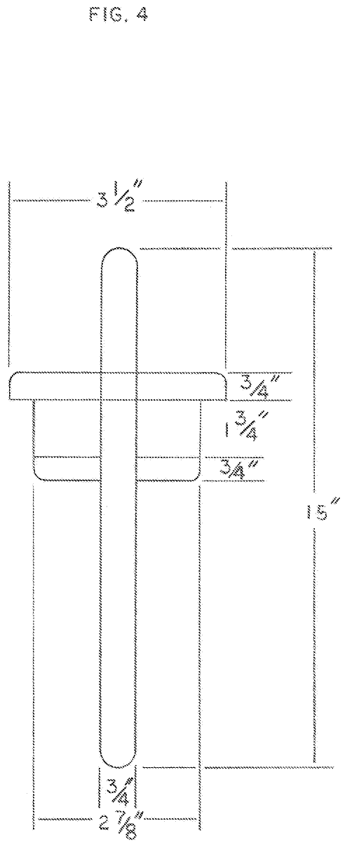

FIG. 5 shows the functional view of the upper (rear) rack assembly that supports the upper tips of each rod and can accommodate both baitcast and spinning rods which have very different eyelet configurations. This view also exhibits the same updated eyebolt fastening method detailed in FIG. 3.

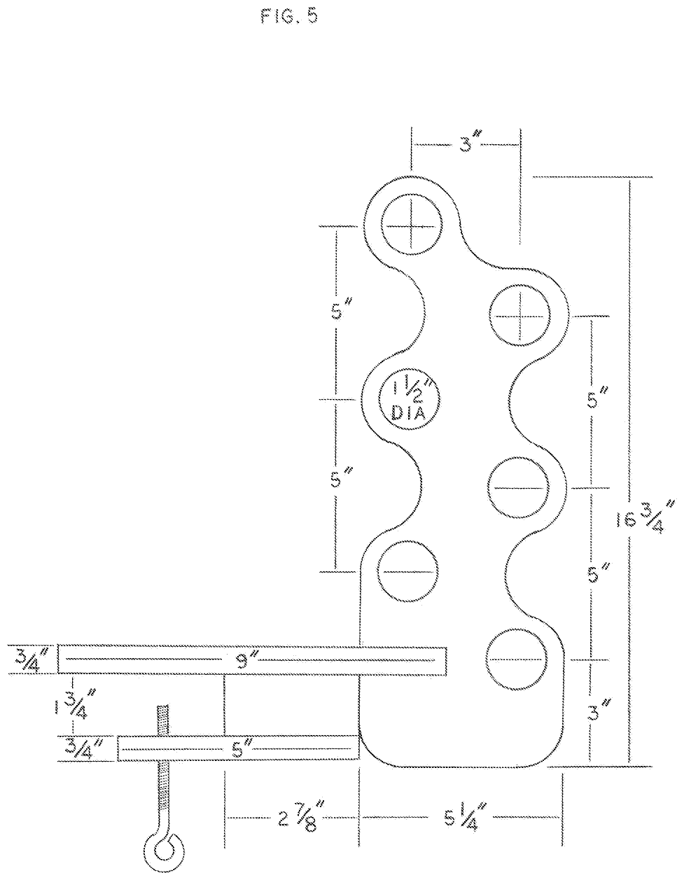

FIG. 6 shows the lateral view of the upper (rear) assembly and provides all dimensions of that view.

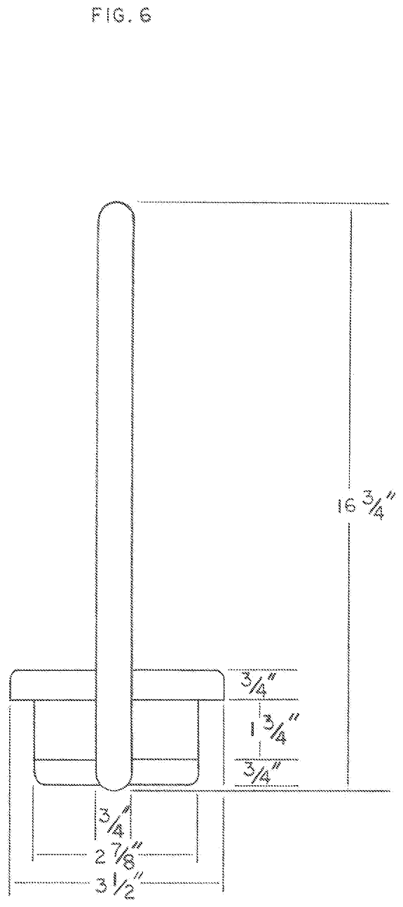

FIG. 7 shows a perspective view of the components installed on the left bed rail of a standard full-sized pickup truck. This drawing also shows a rough depiction of a rod and reel combination ready for transport on the two Rod Rack assemblies.

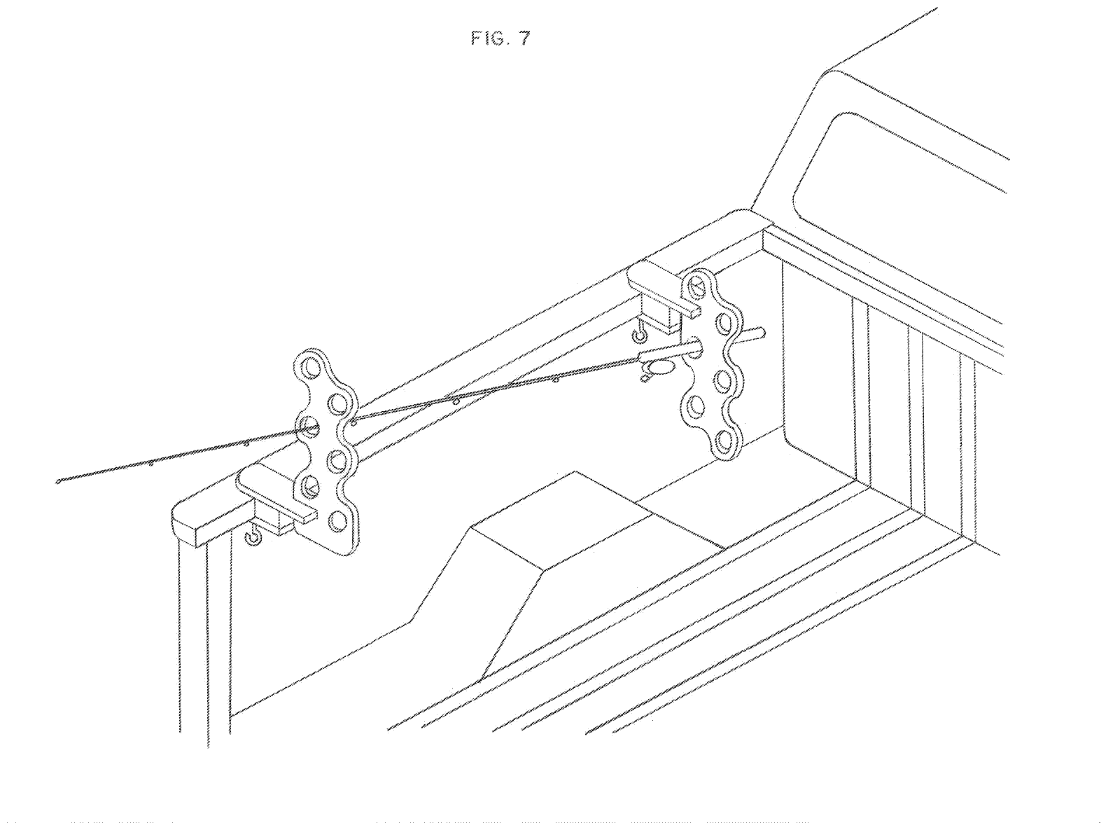

### DETAILED DESCRIPTION OF THE INVENTION

These components were all manufactured in the small workshop in the inventor's garage and finished with Minwax brand stain and two coats of clear Minwax polyurethane. The prototype components are fully constructed from pine boards available in any lumber yard or home improvement center in the United States. Specifically, 1″×4″ and 4″×4″ boards were used to cut the frame pieces and 1″×6″ boards were used to cut and drill the rod support pieces. The three pieces that comprise the frame are designed to fit both above and below the truck bed rail and securely lock the assembly in place with the use of the 4″×¼″ eyebolt which is attached to the assemblies with T-Nuts. Each of the 9″×3½″×¾″ top frame components are then cut with a jigsaw to produce a ¾ ″×2½″ slot that cradles the rod support upright pieces. The center frame component measures 2⅞″×2⅞″×1¾″ and provides the necessary separation so the frame rides both above and below the truck bed rail. The lower component of the frame measures 2⅞″×5″×¾″ and contains the embedded T-Nut that the allows the eyebolt to adjust for securing and removal of the assemblies. The upright rod support pieces are created using Forstner drill bits to create the large, smooth holes that support the rod handles (1¼″ dia. for the lower (forward) support) and the rod tips (1½″ dia. for the upper (rear) support). The larger holes in the upper (rear) rod support component are designed to facilitate the larger rod eyelets of a spinning rod. The 3″ vertical by 2½″ horizontal offset drill pattern combined with the semi-circular 2½″ dia. jigsaw cuts on the outer edge of both the upper and lower support pieces are designed to minimize the surface area and thereby reduce wind resistance when the truck is in motion with the assemblies installed. The rod support pieces are then smoothed with the use of a ⅜″ round over router bit. This removes the sharp 90 degree edges on all inner and outer drilled and cut surfaces. All pieces are then sanded with 150 grit sandpaper and assembled with wood glue and secured with 2½″ wood screws. The lower assembly fits largely below the bed rail of the truck while the upper assembly rides above the rail and supports the rods at an angle of 20 degrees. This angle allows the mounted equipment to remain in place under its own weight and therefore does not need to be secured to the assemblies in any way. These components can be mass produced entirely of wood with no additional reinforcement or constructed of extruded plastic with a metal flange embedded in the frame components to increase rigidity when tightening the eyebolt.

1. The sole inventor (Lloyd Anthony Warren) claims the functional element of the Pickup Rod Rack for the exclusive use of safely and easily transporting multiple fishing rod and reel combinations in the open bed of any standard light duty pickup truck. This functionality also includes the ability to quickly and easily attach and remove the units to either the left or right sidewall of the pickup bed rail on any standard pickup in less than two minutes. This functional design allows the assemblies to connect to the bed rails without causing any marring or damage to the visible surface of the truck rails whether painted metal or a plastic or polymer cover. The binding mechanism makes contact only with the steel underside of the rails so that any pressure exerted by the eyebolt when tightened is applied to the hidden portion of the bed rail. The units can be used on either the driver or passenger side of the bed with no modifications whatsoever. Two sets of the Pickup Rod Rack can be used simultaneously to double the carrying capacity of fishing equipment and the bed of the truck and the tailgate continue to function normally since each unit requires approximately 5% of the open space in the forward corners of the bed. Access to the bed via the tailgate remains fully unobstructed for loading other gear such as coolers, tackle boxes, chairs, tents, etc.
The sole inventor (Lloyd Anthony Warren) also claims the offset drilled pattern and beveled edge design of the rod support components which makes the assemblies more aerodynamic to reduce wind drag on the upper element when the vehicle is in motion. These components have been road tested at speeds up to 70 mph with no shifting or loss of any mounted equipment. By reducing the surface area of the rod support components, I was also able to reduce the overall weight of the assembled units. The second advantage to beveling the drilled holes in the rod support components is that the smooth curved surface prevents any scratching or wear on the finish of the fishing rods when installed and encountering minor vibration from the vehicle and the force of the wind.
